(19) United States
(12) Patent Application Publication
(10) Pub. No.: US 2013/0132245 A1
(43) Pub. Date: May 23, 2013

(54) CHARGING MANAGEMENT SYSTEM AND METHOD

(71) Applicants: Kuan-Hong HSIEH, Tu-Cheng (TW); Chih-San CHIANG, Tu-Cheng (TW); Han-Che WANG, Tu-Cheng (TW); Hua-Dong CHENG, Shenzhen City (CN); Li-Zhang HUANG, Tu-Cheng (TW)

(72) Inventors: Kuan-Hong HSIEH, Tu-Cheng (TW); Chih-San CHIANG, Tu-Cheng (TW); Han-Che WANG, Tu-Cheng (TW); Hua-Dong CHENG, Shenzhen City (CN); Li-Zhang HUANG, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/310,809

(22) Filed: Dec. 5, 2011

(30) Foreign Application Priority Data
Nov. 21, 2011 (CN) 201110370975.X

(51) Int. Cl. G06Q 30/04

(52) U.S. Cl. 705/34

(57) ABSTRACT

A charging management system applied in a public facility includes a communicating unit communicating with a server with an online payment system, a charge interface, a power converting unit, a billing unit, and a control unit. The power converting unit converts power provided by a power supply to charge an electronic device connected to the charge interface. The control unit generates an electronic bill according to a charging cost computed by the billing unit, sends the electronic bill to the server, and communicates with the online payment system of the server to pay for the electronic bills. A related method is also provided.

### BACKGROUND

1. Technical Field

The present disclosure relates to charging management systems, and particularly, to a charging management system applied in public facilities to charge an electronic device, and a method employed by the charging management system.

2. Description of the Related Art

Electric vehicles, such as electric cars, can be charged at charging posts provided by a limited number of traditional public charging stations whose locations are fixed. Due to the maneuverability of the electric vehicles, the traditional public charging station lacks flexibility and convenience. Power supplies of some public facilities, such as street lights, have been provided in many places. Therefore, there is room for improvement within the power supplies of the public facilities to charge for the electric vehicles.

### BRIEF DESCRIPTION OF THE DRAWINGS

The components in the drawing are not necessarily drawn to scale, the emphasis instead being placed upon clearly illustrating the principles of the disclosure. Moreover, in the drawings, like reference numerals designate corresponding parts throughout the several views.

FIG. 1 is a block diagram of a charging management system employed in a public facility in accordance with an exemplary embodiment.

FIG. 2 is a flow diagram that describes steps in a method for charging management in accordance with an exemplary embodiment.

### DETAILED DESCRIPTION

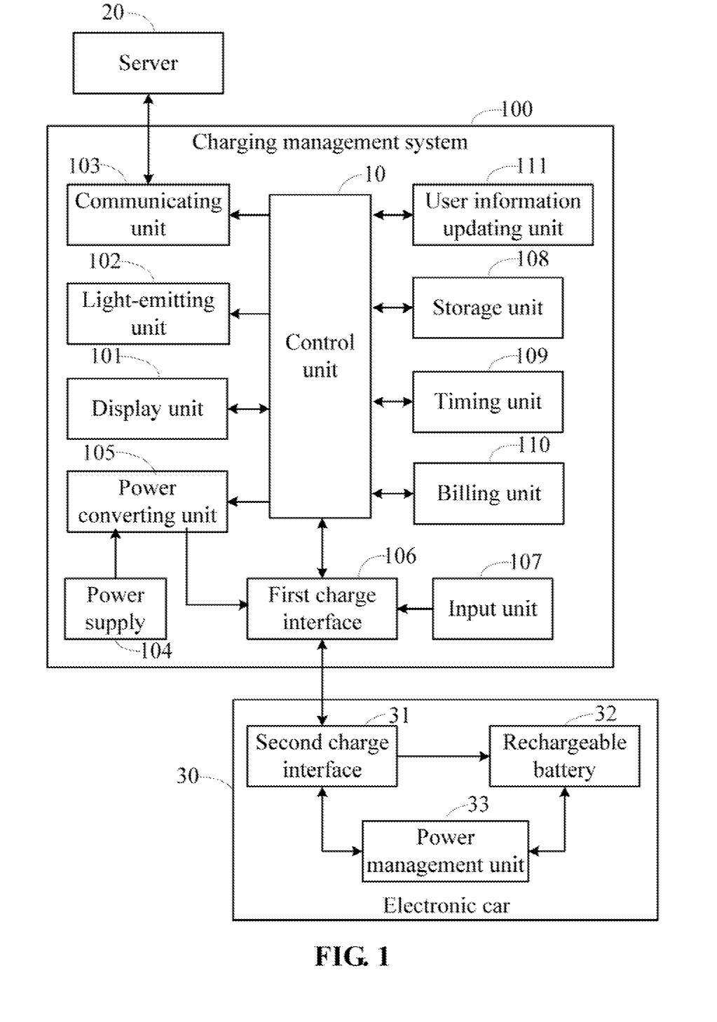

FIG. 1 is a block diagram of a charging management system applied in a public facility in accordance with an exemplary embodiment. The charging management system 100 is capable of charging electronic devices. In the embodiment, the charging management system 100 is applied in a street light system, and is capable of charging an electric car 30.

The charging management system 100 includes a control unit 10, a display unit 101, a light-emitting unit 102, a power supply 104, a power converting unit 105, a first charge interface 106, an input unit 107, and a storage unit 108. The light-emitting unit 102 is mounted on a lamp pole for lighting. The power supply 104 may be a solar power supply. The first charge interface 106 is mounted on the lamp pole. The input unit 107 connected to the first charge interface 106 is provided for users to input user information such as user names, license number of the electric car 30, and passwords. The control unit 10 controls the display unit 101 to display the input user information. In the embodiment, the input unit 107 is a keyboard, and is connected to the first charge interface 106 via a power wire to transmit data.

The electric car 30 includes a second charge interface 31, a battery 32, and a power management unit 33. The second charge interface 31 is connected to the first charge interface 106 to charge the electric car 30 by the charging management system 100. The power management unit 33 stores battery information of the battery 32, and monitors the battery 32 when being charged. The battery information of the battery 32 includes an input voltage, an input current, and an input frequency of the battery 32.

When the first charge interface 106 is connected to the second charge interface 31, the control unit 10 obtains the battery information from the power management unit 33 and stores the obtained battery information in the storage unit 108. The power converting unit 105 converts power provided by the power supply 104 to appropriate power for charging the battery 32 according to the obtained battery information. In the embodiment, the first charge interface 106 and the second interface 31 are connected through a wire. In an alternative embodiment, the first charge interface 106 and the second charge interface 31 are wirelessly connected, by wireless fidelity (WiFi), BLUETOOTH (BT), for example.

The charging management system 100 further includes a timing unit 109 and a billing unit 110. When the battery 32 is charged by the power supply 104, the control unit 10 controls the timing unit 109 to time an endured charging time of the battery 32, the billing unit 110 to account a charging cost, and the display unit 101 to display the charging time and the charging cost. In the embodiment, a unit price of electric quantity is pre-obtained by the billing unit 110.

The charging management system 100 further includes a communicating unit 103 and a user information updating unit 111. The communicating unit 103 communicates with a server 20 via a network, such as the Internet, virtual private network (VPN), WiFi, for example. In the embodiment, the server 20 is a computer terminal server. The server 20 includes an online payment system. A user information table is stored in the server 20. The user information table stores user information of registered users, such as registered users' names, license numbers, passwords, bank accounts, paid bills and unpaid bills.

The user information updating unit 111 obtains the user information table from the server 20 via the communicating unit 103 periodically, and stores the user information table to the storage unit 108. In the embodiment, when the input unit 107 receives user information input by the user, the control unit 10 determines whether the input user information is registered in the user information table stored in the storage unit 108. If the input user information is registered in the user information table, the control unit 10 enables the power converting unit 105 to convert the power to charge the battery 32 when the first charge interface 106 is connected to the second charge interface 31.

The control unit 10 determines whether the battery 32 is fully charged or not, and disables the power converting unit 105 to charge the battery 32 if the battery 32 is fully charged, and further disables the timing unit 109 to stop timing the endured charging time and the billing unit 110 to stop accumulating the charge cost. The control unit 10 generates an electronic bill according to the finial charging cost accumulated by the billing unit 110 and the user information input by the input unit 107. In addition, controls the communicating unit 103 to transmit the electronic bill to the server 20, so that the server 20 records the electronic bill as an unpaid bill under the name of the registered user.

Furthermore, the control unit 10 receives the corresponding bank account, the paid bills, and unpaid bills under the name of the registered user from the server 20, and displays an operating user interface to display the bank account, the paid bills, and unpaid bills on the display unit 101. The control unit 10 further determines whether the registered user selects one or more unpaid bills according to the registered user's operations on the operating user interface.

When one or more unpaid bills are selected, the control unit 10 communicates with the online payment system of the server 20 via the communicating unit 103, and displays a paying user interface of the online payment system on the display unit 101 for the registered user to pay for the selected one or more unpaid bills.

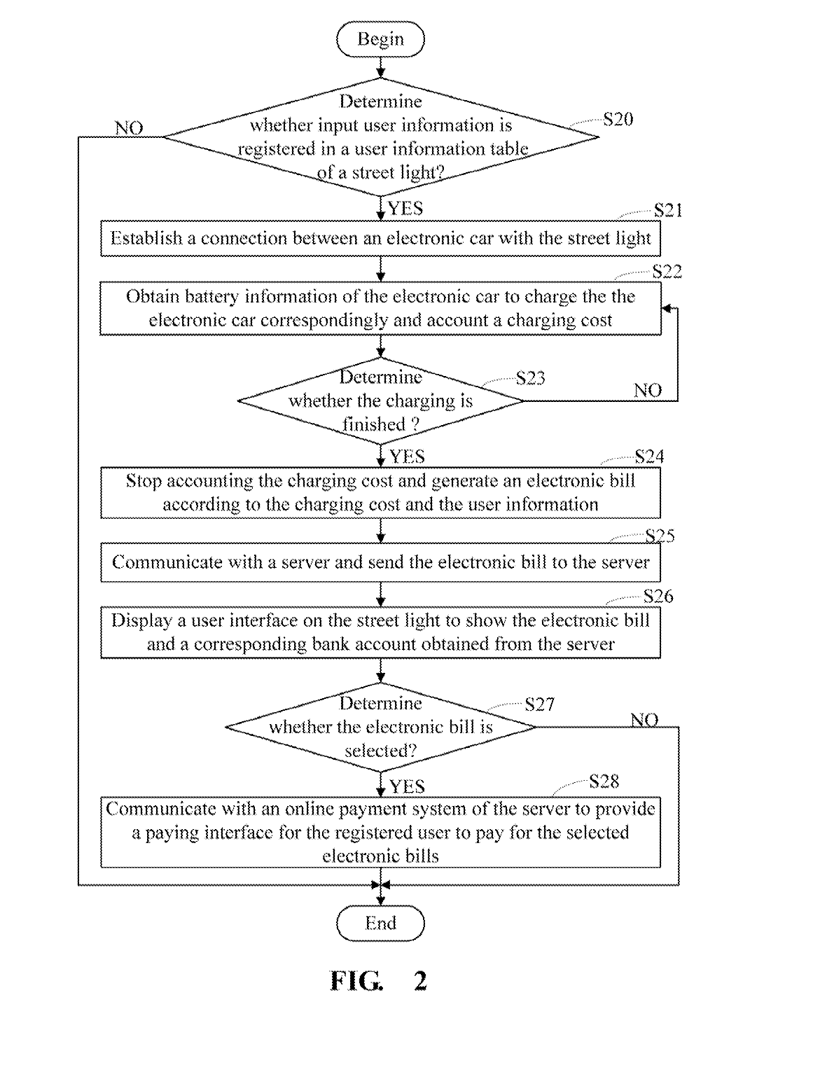

FIG. 2 is a flowchart illustrating a method capable of charging the electric car 30 employed in the charging management system 100 in accordance with an exemplary embodiment.

In step S20, the user inputs the user information by the input unit 107 connected to the first charge interface 106, the control unit 10 determines whether the input user information is registered in the user information table stored in the storage unit 108. If yes, the procedure goes to step S21, otherwise, the procedure ends.

In the embodiment, the input unit 107 is a keyboard, and is connected to the first charge interface 106 via the power wire enabling to transmit data.

The user information includes user names, licenses number of the electric car 30, and password, and the control unit 10 displays the input user information on the display unit 101.

In step S21, the first charge interface 106 is connected to the second charge interface 31 to connect the electric car 30 to the street light.

In step S22, the control unit 10 obtains the battery information of the battery 32 from the power management unit 33 and stores the obtained battery information in the storage unit 108. In addition, the power converting unit 105 converts the power provided by the power supply 104 to appropriate power for charging the batter 32 according to the obtained battery information, and further controls the timing unit 109 to time the endured charging time of the battery 32, and the billing unit 109 to account the charging cost. The battery information includes the input voltage, the input current, and the input frequency of the battery 32.

In the embodiment, the first charge interface 106 and the second interface 31 are connected through a wire. In an alternative embodiment, the first charge interface 106 and the second charge interface 31 are connected wirelessly, through wireless fidelity (WiFi), BLUETOOTH (BT), for example.

In step S23, the control unit 10 determines whether the battery 32 is finished or not, if yes, the procedure goes to step S24, otherwise, the procedure returns to step S22.

In step S24, the control unit 10 disables the power converting unit 105 to charge the battery 32. In addition, further disables the timing unit 109 to stop timing the endured charging time and the billing unit 110 to stop accumulating the charging cost, and generates the electronic bill according to the finial charging cost accumulated by the billing unit 110 and the user information input by the input unit 107.

In step S25, the charging management system 100 communicates with the server 20 via the communicating unit 103, and the control unit 10 controls the communicating unit 103 to send the electronic bill generated to the server 20.

In step S26, the server 20 records the electronic bill received from the charging management system 100 as an unpaid bill under the name of the registered user to the user information table. The control unit 10 displays the operating user interface on the display unit 101 to show the bank account, the paid bills, and unpaid bills on the display unit 101.

In step S27, the control unit 10 determines whether the registered user selects one or more unpaid bills according to the operations of the registered user on the user interface, if yes, the procedure goes to step S28, otherwise, the procedure ends.

In step S28, the control unit 10 communicates with the online payment system of the server 20 to provide the paying interface of the online payment system for the registered user to pay for the selected one or more unpaid bills.

It is understood that the present disclosure may be embodied in other forms without departing from the spirit thereof. Thus, the present examples and embodiments are to be considered in all respects as illustrative and not restrictive, and the disclosure is not to be limited to the details given herein.

1. A charging management system applied in a public facility comprising:
a communicating unit configured to communicate with a server which comprises an online payment system;
a charge interface configured to connect an electronic device;
a billing unit configured to compute a charging cost of the electronic device;
a storage unit configured to store a user information table, which records user information of registered users;
a control unit configured for:
determining whether user information of the electronic device is registered in the user information table;
generating an enabling signal if the user information of the electronic device is registered in the user information table;
obtaining battery information of the electronic device via the charge interface;
generating an electronic bill according to the charging cost computed by the billing unit; and
sending the electronic bill to the server to communicate with the online payment system of the server via the communicating unit for paying for the electronic bill;
a power converting unit configured to convert power provided by a power supply to appropriate power according to the battery information, and charging the electronic device via the charge interface in response to the enabling signal;
a display unit configured to display the charging cost during a progress of charging the electronic device, and a user interface of the online payment system of the server during a progress of paying for the electronic bill.

2. (canceled)

3. The charging management system as recited in claim 1, wherein the battery information comprises an input voltage, an input current, and an input frequency of a battery of the electronic device.

4. The charging management system as recited in claim 1, further comprising a timing unit, configured to time a charging time of the electronic device; the display unit is further configured to display the charging time.

5. (canceled)

6. The charging management system as recited in claim 1, further comprising a user information updating unit configured to update the user interface table stored in the storage unit according to user information table obtained from the server periodically.

7. The charging management system as recited in claim 1, wherein the user information table records registered users' names, passwords, bank accounts, paid bills and unpaid bills.

8. The charging management system as recited in claim 1, further comprising an input unit connected to the charge interface, configured to input user information and receive pay for the electronic bills.

9. A method employed by a charging management system applied in a public facility comprising:
(1) receiving user information and determining whether the user information is registered in a user information table;
(2) establishing a connection with an electronic device if the user information is determined to be registered;
(3) obtaining battery information of a battery of the electronic device, converting power provided by a power supply to appropriate power for charging the battery according to the battery information, and computing a charging cost of the electronic device;
(4) determining whether the charging is finished or not;
(5) generating an electronic bill if the charging is finished;
(6) communicating with a server, and sending the electronic bill to the server;
(7) displaying a user interface to show electronic bills and a corresponding bank account obtained from the server;
(8) communicating with an online payment system of the server to provide a paying interface of the online payment system to enable a user of the electronic device to pay for the electronic bills.

10. (canceled)

11. The method as recited in claim 9, wherein the user information table records registered user information comprising registered users' names, passwords, bank accounts, prepaid bills and unpaid bills and is stored in the charging management system.

12. The method as recited in claim 9, wherein the battery information comprises an input voltage, an input current, and an input frequency of a battery of the electronic device.

13. The method as recited in claim 9, further comprising prior to the step (8), determining whether the electronic bill is selected by the user according to the user's operations on the user interface, and going to the step (8) if the electronic bill is selected.
